(19) United States
(12) Patent Application Publication
(10) Pub. No.: US 2007/0067770 A1
(43) Pub. Date: Mar. 22, 2007

(54) System and method for reduced overhead in multithreaded programs

(76) Inventor: Christopher Michael Thomasson, Antioch, CA (US)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 11/228,995

(22) Filed: Sep. 16, 2005

(51) Int. Cl. G06F 9/46

(52) U.S. Cl. 718/100

(57) ABSTRACT

One aspect of the invention involves a computer-implemented method for: receiving a request at a polling thread from one application thread in a plurality of application threads to modify a data object shared by the plurality of application threads; determining if there are any persistent references to the data object by application threads in the plurality of application threads; and granting the request if there are no persistent references to the data object by application threads in the plurality of application threads. Each application thread in the plurality of application threads: performs synchronization operations episodically or periodically, each performance of the synchronization operations comprising an iteration of the synchronization operations; deletes all of the application thread's non-persistent references, if any, prior to completing each iteration of the synchronization operations; and continues execution after making requests to modify data objects shared by the plurality of application threads.

### TECHNICAL FIELD

The disclosed embodiments relate generally to multithreaded computer programs. More particularly, the disclosed embodiments relate to systems and methods to reduce overhead in multithreaded computer programs.

### BACKGROUND

Multithreaded programs increase computer system performance by having multiple threads execute concurrently on multiple processors. The threads typically share access to certain system resources, such as data structures (e.g., objects) in a shared memory. Different threads may want to perform different operations on the same data structure. For example, some threads may want to just read information in the data structure, while other threads may want to update, delete, or otherwise modify the same data structure. Consequently, synchronization is needed maintain data coherency, i.e., to ensure that the threads have a consistent view of the shared data.

Various synchronization methods and systems have been developed to maintain data coherency. For example, mutual-exclusion mechanisms such as locks are often used to allow just a single thread to access and/or change a shared data structure. U.S. Pat. Nos. 6,219,690; 5,608,893; and 5,442,758, describe a read-copy-update (“RCU”) process that reduces the number of locks needed when accessing shared data.

However, RCU and other existing synchronization methods and systems still create significant overhead that diminishes the performance benefits of multithreaded programming. Thus, it would be highly desirable to create more efficient systems and methods for reducing overhead in multithreaded programs.

### SUMMARY

One aspect of the invention involves a computer-implemented method for: receiving a request at a polling thread from one application thread in a plurality of application threads to modify a data object shared by the plurality of application threads; determining if there are any persistent references to the data object by application threads in the plurality of application threads; and granting the request if there are no persistent references to the data object by application threads in the plurality of application threads. Each application thread in the plurality of application threads: performs synchronization operations episodically or periodically, each performance of the synchronization operations comprising an iteration of the synchronization operations; deletes all of the application thread's non-persistent references, if any, prior to completing each iteration of the synchronization operations; and continues execution after making requests to modify data objects shared by the plurality of application threads.

Another aspect of the invention involves a multiprocessor computer system that includes a main memory, a plurality of processors, and a program. The program is stored in the main memory and executed by the plurality of processors. The program includes: instructions for receiving a request at a polling thread from one application thread in a plurality of application threads to modify a data object shared by the plurality of application threads; instructions for determining if there are any persistent references to the data object by application threads in the plurality of application threads; and instructions for granting the request if there are no persistent references to the data object by application threads in the plurality of application threads. Each application thread in the plurality of application threads: performs synchronization operations episodically or periodically, each performance of the synchronization operations comprising an iteration of the synchronization operations; deletes all of the application thread's non-persistent references, if any, prior to completing each iteration of the synchronization operations; and continues execution after making requests to modify data objects shared by the plurality of application threads.

Another aspect of the invention involves a computer-program product that includes a computer readable storage medium and a computer program mechanism embedded therein. The computer program mechanism includes instructions, which when executed by a multiprocessor computer system, cause the multiprocessor computer system to: receive a request at a polling thread from one application thread in a plurality of application threads to modify a data object shared by the plurality of application threads; determine if there are any persistent references to the data object by application threads in the plurality of application threads; and grant the request if there are no persistent references to the data object by application threads in the plurality of application threads. Each application thread in the plurality of application threads: performs synchronization operations episodically or periodically, each performance of the synchronization operations comprising an iteration of the synchronization operations; deletes all of the application thread's non-persistent references, if any, prior to completing each iteration of the synchronization operations; and continues execution after making requests to modify data objects shared by the plurality of application threads.

Another aspect of the invention involves a multiprocessor computer system with means for receiving a request at a polling thread from one application thread in a plurality of application threads to modify a data object shared by the plurality of application threads; means for determining if there are any persistent references to the data object by application threads in the plurality of application threads; and means for granting the request if there are no persistent references to the data object by application threads in the plurality of application threads. Each application thread in the plurality of application threads: performs synchronization operations episodically or periodically, each performance of the synchronization operations comprising an iteration of the synchronization operations; deletes all of the application thread's non-persistent references, if any, prior to completing each iteration of the synchronization operations; and continues execution after making requests to modify data objects shared by the plurality of application threads.

Thus, the present invention reduces overhead in multithreaded programs by allowing application threads to obtain object references without using resource intensive operations such as StoreLoad style memory barriers or mutex operations, and by efficiently determining when a data object in shared memory is not referenced by any application thread so that the shared data object can be modified while maintaining data coherency.

### BRIEF DESCRIPTION OF THE DRAWINGS

For a better understanding of the aforementioned aspects of the invention as well as additional aspects and embodiments thereof, reference should be made to the Description of Embodiments below, in conjunction with the following drawings in which like reference numerals refer to corresponding parts throughout the figures.

FIG. 1 is a block diagram illustrating an exemplary multiprocessor computer system in accordance with one embodiment of the present invention.

FIG. 2 is a block diagram illustrating an embodiment of an application thread in greater detail.

FIG. 3 is a block diagram illustrating an embodiment of a polling thread in greater detail.

FIG. 4A is a flowchart representing a method of acquiring a persistent reference in accordance with one embodiment of the present invention.

FIG. 4B is a flowchart representing a method of releasing a persistent reference in accordance with one embodiment of the present invention.

FIG. 5A is a flowchart representing a method of acquiring a non-persistent reference in accordance with one embodiment of the present invention.

FIG. 5B is a flowchart representing a method of releasing a non-persistent reference in accordance with one embodiment of the present invention.

FIG. 6A is a flowchart representing a method of registering an application thread with the polling thread in accordance with one embodiment of the present invention.

FIG. 6B is a flowchart representing a method of synchronizing an application thread with shared memory in accordance with one embodiment of the present invention.

FIG. 6C is a flowchart representing a method of executing a memory barrier instruction and marking an application thread as synchronized in more detail.

FIG. 7 is a flowchart representing a method of synchronizing an application thread with shared memory and making the application thread inactive in accordance with one embodiment of the present invention.

FIG. 8 is a flowchart representing a method of making an application thread active, but not ready for the polling thread synchronization process in accordance with one embodiment of the present invention.

FIG. 9 is a flowchart representing a method of synchronizing an application thread with shared memory and making the application thread ready for the polling thread synchronization process in accordance with one embodiment of the present invention.

FIG. 10A is a flowchart representing a method for an application thread to make a request to modify a shared object in accordance with one embodiment of the present invention.

FIG. 10B is a flowchart representing another method for an application thread to make a request to modify a shared object in accordance with one embodiment of the present invention.

FIG. 11A is a flowchart representing a process for polling thread synchronization in accordance with one embodiment of the present invention.

FIG. 11B is a flowchart representing another process for polling thread synchronization in accordance with one embodiment of the present invention.

FIG. 11C is a flowchart representing a method for checking registered threads to determine if all such threads are ready for the polling thread synchronization process in accordance with one embodiment of the present invention.

FIGS. 12A and 12B are a flowchart representing another process for polling thread synchronization in accordance with one embodiment of the present invention.

### DESCRIPTION OF EMBODIMENTS

Methods and systems are described that show how to reduce overhead in multithreaded programs. Reference will be made to certain embodiments of the invention, examples of which are illustrated in the accompanying drawings. While the invention will be described in conjunction with the embodiments, it will be understood that it is not intended to limit the invention to these particular embodiments alone. On the contrary, the invention is intended to cover alternatives, modifications and equivalents that are within the spirit and scope of the invention as defined by the appended claims.

Moreover, in the following description, numerous specific details are set forth to provide a thorough understanding of the present invention. However, it will be apparent to one of ordinary skill in the art that the invention may be practiced without these particular details. In other instances, methods, procedures, components, and networks that are well-known to those of ordinary skill in the art are not described in detail to avoid obscuring aspects of the present invention.

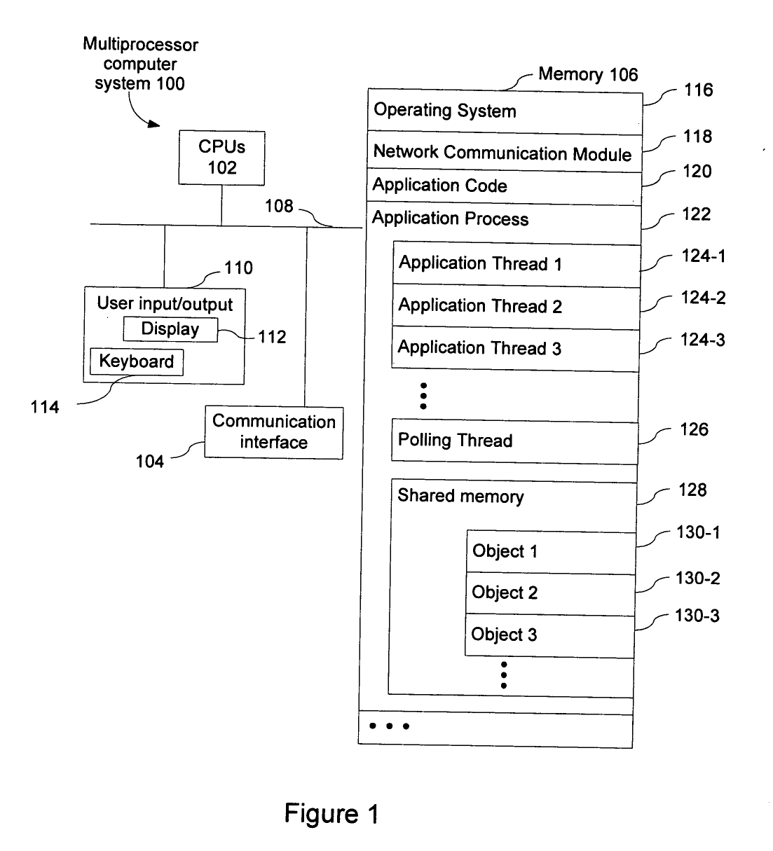

FIG. 1 is a block diagram illustrating an exemplary multiprocessor computer system 100 in accordance with one embodiment of the present invention. Computer 100 typically includes multiple processing units (CPUs) 102, one or more network or other communications interfaces 104, memory 106, and one or more communication buses 108 for interconnecting these components. Computer 100 optionally may include a user interface 110 comprising a display device 112 and a keyboard 114. Memory 106 may include high speed random access memory and may also include non-volatile memory, such as one or more magnetic disk storage devices. Memory 106 may optionally include one or more storage devices remotely located from the CPUs 102. In some embodiments, the memory 106 stores the following programs, modules and data structures, or a subset or superset thereof:
an operating system 116 that includes procedures for handling various basic system services and for performing hardware dependent tasks;
a network communication module 118 that is used for connecting multiprocessor computer 102 to other computers via one or more communication network interfaces 104 (wired or wireless), such as the Internet, other wide area networks, local area networks, metropolitan area networks, and so on;
application code 120 that includes instructions for one or more multithreaded programs; and
application process 122 that executes instructions for one or more multithreaded programs in application code 120, which includes:
   a plurality of application threads 124 for concurrently executing instructions on multiple CPUs 102,
   shared memory 128 that includes data structures (e.g., objects 130) that may be accessed, referenced, or otherwise used by one or more application threads 124, and
   a polling thread 126 that is used to determine when application thread requests to modify shared data structures (e.g., objects 130) can be granted.

Each of the above identified modules and applications corresponds to a set of instructions for performing a function described above. These modules (i.e., sets of instructions) need not be implemented as separate software programs, procedures or modules, and thus various subsets of these modules may be combined or otherwise re-arranged in various embodiments. In some embodiments, memory 106 may store a subset of the modules and data structures identified above. Furthermore, memory 106 may store additional modules and data structures not described above.

Although FIG. 1 shows multiprocessor computer system 100 as a number of discrete items, FIG. 1 is intended more as a functional description of the various features which may be present in computer 100 rather than as a structural schematic of the embodiments described herein. In practice, and as recognized by those of ordinary skill in the art, items shown separately could be combined and some items could be separated.

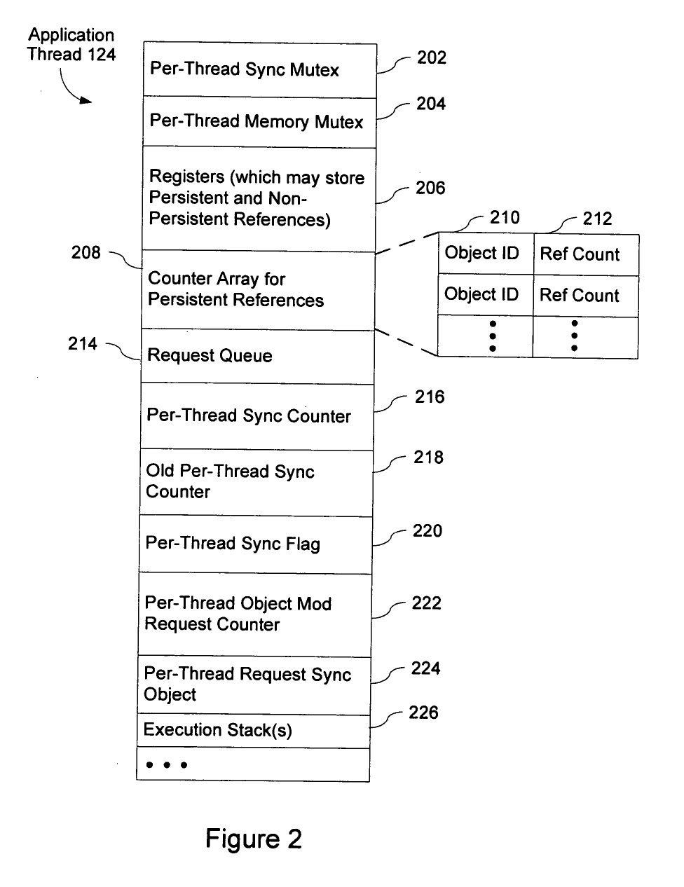

FIG. 2 is a block diagram illustrating an embodiment of an application thread 124 in greater detail. In some embodiments, application thread 124 includes the following elements, or a subset or superset of such elements:
a per-thread synchronization mutex 202 that is normally unlocked, but which is briefly locked during application thread and polling thread synchronization processes to protect the variables in application thread 124;
a per-thread memory mutex 204 that is normally locked, but which is briefly unlocked during an application thread synchronization process to ensure that the polling thread 126 will get a full view of application thread 124's modifications to memory;
registers 206 that can store persistent and non-persistent references to shared data objects 130;
a counter array for persistent references 208 that keeps track of application thread 124's persistent references, which includes an object ID 210 and reference count 212 for each persistent reference in application thread 124;
a request queue 214 that stores application thread 124's requests to modify shared data objects 130;
a per-thread synchronization counter 216 that tracks how many times application thread 124 has performed an application thread synchronization process;
an old per-thread synchronization counter 218 that is used in conjunction with the per-thread synchronization counter 216 to determine if an active application thread is ready or not ready for the polling thread synchronization process; in some embodiments, a per-thread flag is used, rather than counters 216 and 218, to determine the readiness of an active application thread for the polling thread synchronization process;
a per-thread synchronization flag 220 that is used to determine if an application thread is in an inactive state; for example, in some embodiments, an application thread is in an inactive state if its per-thread synchronization flag 220 is set to zero;
a per-thread object modification request counter 222 that keeps track of the total number of object modification requests currently in request queue 214;
a per-thread request synchronization object or condition variable 224 that is used by a set of instructions that ensure that application thread 124 does not exhaust all of the system memory by making too many object modification requests; and
execution stack(s) 226 that contain local variables and parameters associated with programs executed by application thread 124.

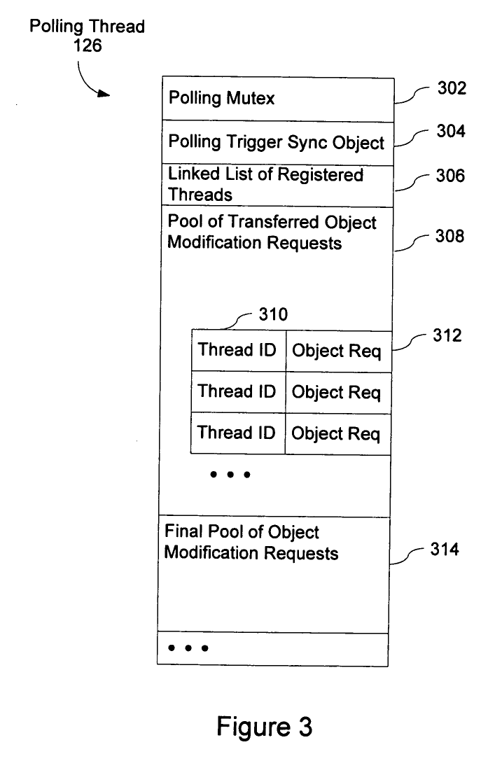

FIG. 3 is a block diagram illustrating an embodiment of polling thread 126 in greater detail. In some embodiments, polling thread 126 includes the following elements, or a subset or superset of such elements:
a polling mutex 302 that is used to protect polling thread 126's variables during the polling thread synchronization process;
a polling trigger synchronization object or condition variable 304 that is used to trigger the polling thread synchronization process (e.g., after a predetermined event or a predetermined amount of time);
a linked list 306 of application threads 124 that have registered with polling thread 126;
a pool of transferred object modification requests 308 (received from the application threads 124) that includes a thread ID 310 and corresponding object request 312 for each request in the pool; and
a final pool of object modification requests 314 that are evaluated by the polling thread 126.

An application thread 124 may contain two types of references to data objects 130 in shared memory 128, namely persistent references and non-persistent references.

As used in the specification and claims, a “persistent reference” is a reference (e.g., a pointer) to a shared data structure (e.g., object 130), where the persistent reference can exist in a respective application thread 124 both before and after a respective synchronization operation of the application thread 124.

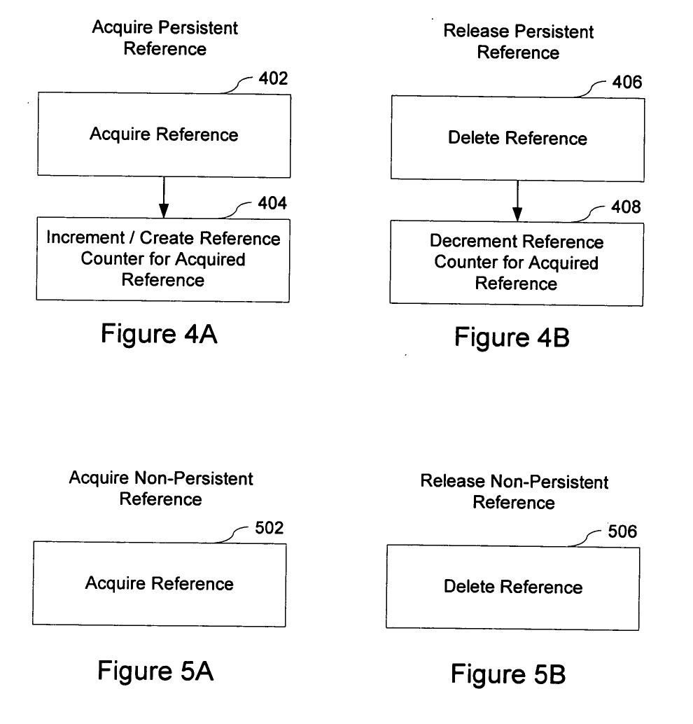

FIG. 4A is a flowchart representing a method of acquiring a persistent reference in accordance with one embodiment of the present invention. Application thread 124 acquires (402) a reference to object 130. In some embodiments, application thread 124 creates or otherwise acquires the reference by loading a pointer to object 130 into a local variable in application thread 124, such as one of the thread's registers 206. In some embodiments (e.g., embodiments implemented on Alpha microprocessors), a data-dependant LoadLoad style memory barrier is used after loading a pointer to object 130 into a local variable in application thread 124. A reference counter is created or incremented (404) for a persistent reference. In some embodiments, a reference counter 212 (which is linked to the referenced object via object ID 210) for the persistent reference is created or incremented in a counter array for persistent references 208 in application thread 124. In some embodiments, the reference counter 212 for a particular object is located by hashing an object ID 210 for the object 130 and using the resulting hash value to look up or otherwise locate the reference counter in the counter array 208 of the thread.

FIG. 4B is a flowchart representing a method of releasing a persistent reference in accordance with one embodiment of the present invention. Application thread 124 deletes (406) a reference to object 130. In some embodiments, application thread 124 deletes the reference by setting a pointer to object 130 to null in a local variable in application thread 124, such as one of the thread's registers 206. A reference counter is decremented (408) for a persistent reference. In some embodiments, a reference counter 212 for the persistent reference is decremented in a counter array for persistent references 208 in application thread 124. In some embodiments, the order of operations 406 and 408 may be reversed.

As used in the specification and claims, a “non-persistent reference” is a reference (e.g., a pointer) to a shared data structure (e.g., object 130) that cannot exist in a respective application thread 124 both before and after a respective synchronization operation of the application thread 124. Non-persistent references are deleted prior to completing each iteration of the synchronization operations of the application thread 124. Since inactive application threads hold no non-persistent object references (as explained elsewhere in this document), even inactive application threads are in compliance with this requirement for non-persistent object references.

The period of time between synchronization operations of an application thread, or more precisely the period of time from the end of one synchronization operation to the end of a next synchronization operation of the application thread, may be called an epoch of the application thread. Any non-persistent object reference held by an application thread exists during only a single epoch of the application thread, because all non-persistent object references are deleted prior to completing the thread's synchronization operations.

FIG. 5A is a flowchart representing a method of acquiring a non-persistent reference in accordance with one embodiment of the present invention. Application thread 124 acquires (502) a reference to object 130. In some embodiments, application thread 124 creates or otherwise acquires the reference by loading a pointer to object 130 into a local variable in application thread 124, such as one of the thread's registers 206. In some embodiments, a data-dependant LoadLoad style memory barrier is used after loading a pointer to object 130 into a local variable in application thread 124.

FIG. 5B is a flowchart representing a method of releasing a non-persistent reference in accordance with one embodiment of the present invention. Application thread 124 deletes (506) a reference to object 130. In some embodiments, application thread 124 deletes the reference by setting a pointer to object 130 to null in a local variable in application thread 124, such as one of the thread's registers 206.

Note that for both persistent and non-persistent references, application thread 124 can acquire (and delete) a reference to a shared data structure (e.g., object 130) without using any synchronization operations and without using any memory barrier operations. For example, there is no need for application thread 124 to use a synchronization mutex (e.g., per-thread sync mutex 202) to either acquire or delete the reference. However, in some embodiments (e.g., embodiments implemented on Alpha microprocessors), the application thread 124 acquires and/or deletes a reference to an object (or other shared data structure) without using any synchronization operations and without using any StoreLoad style memory barrier operations, but the application thread 124 may use a data-dependant LoadLoad style memory barrier instruction.

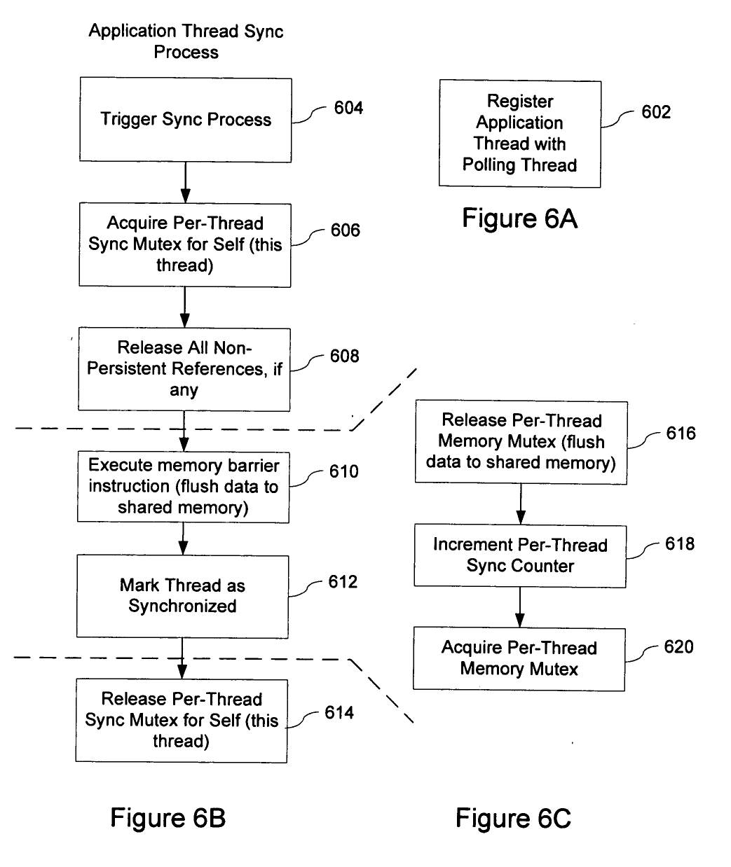

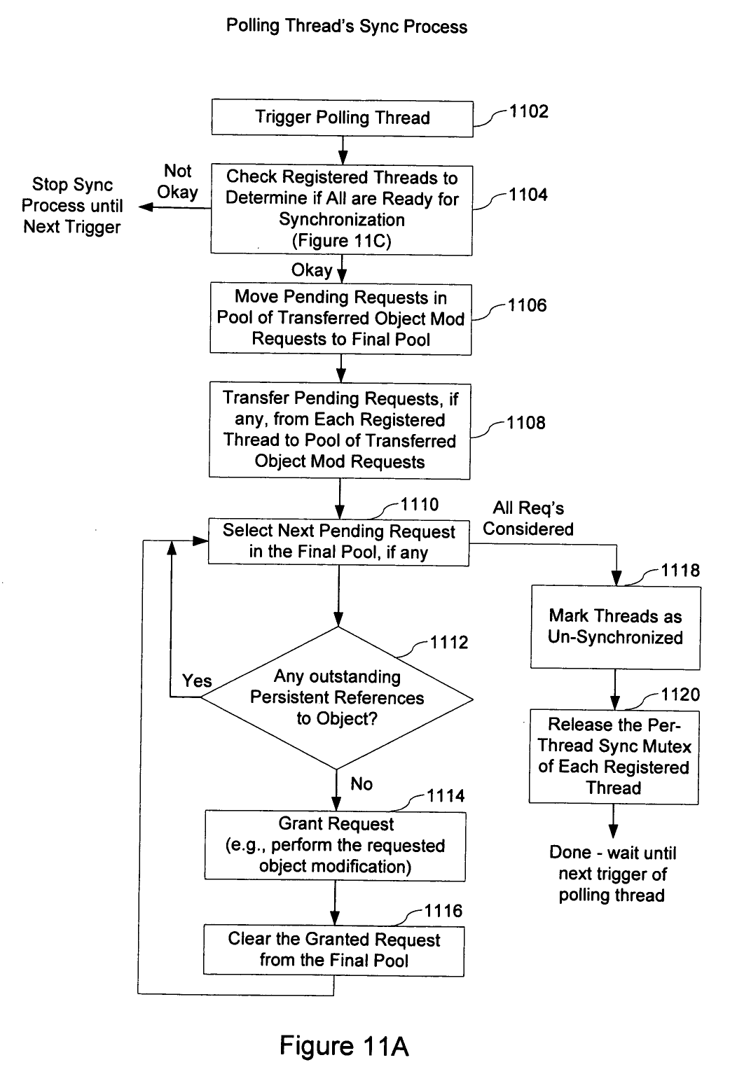

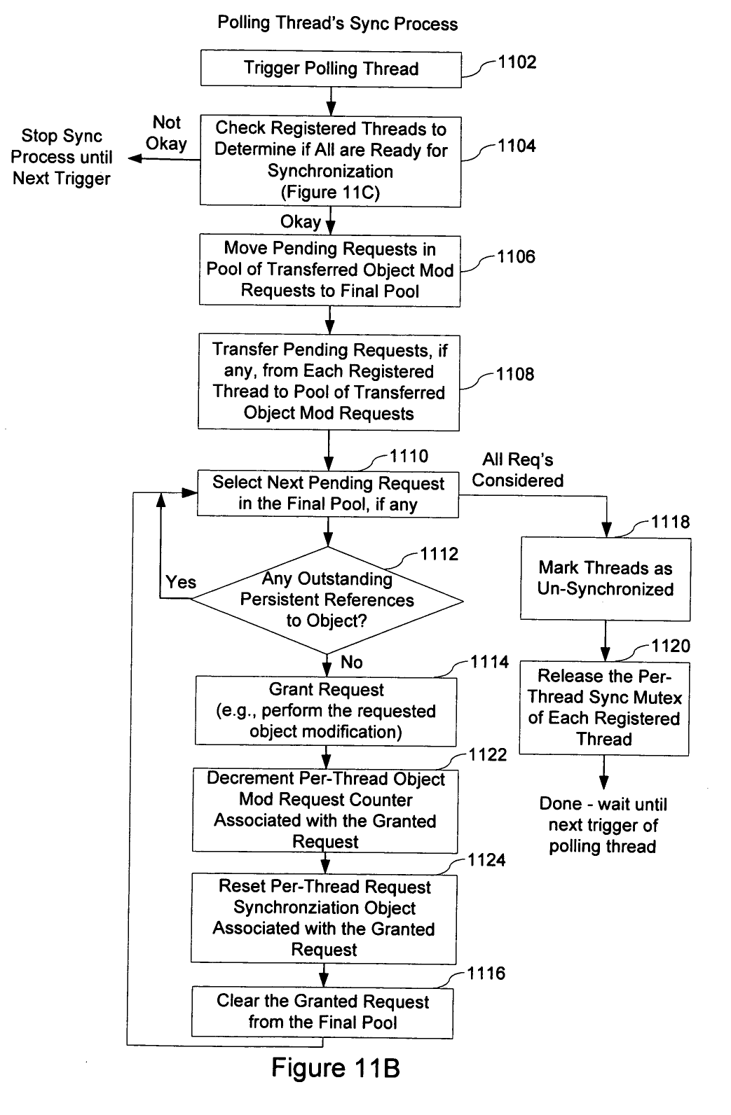

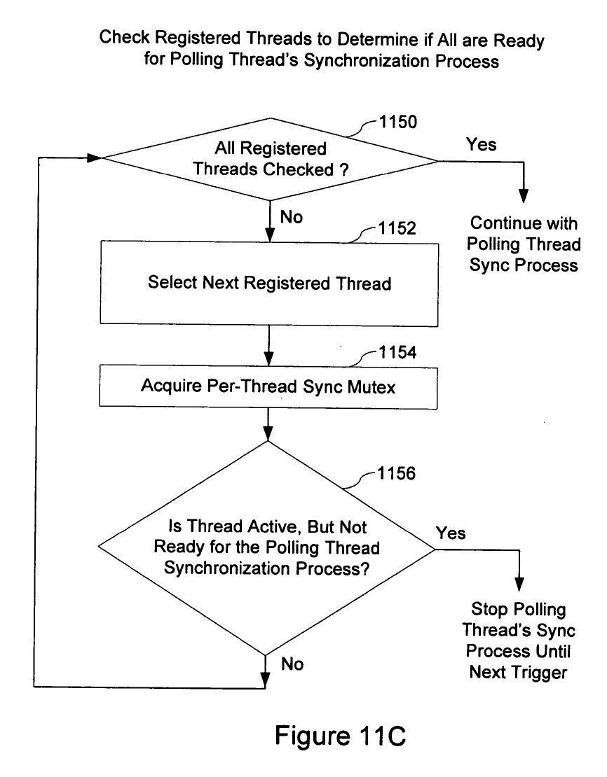

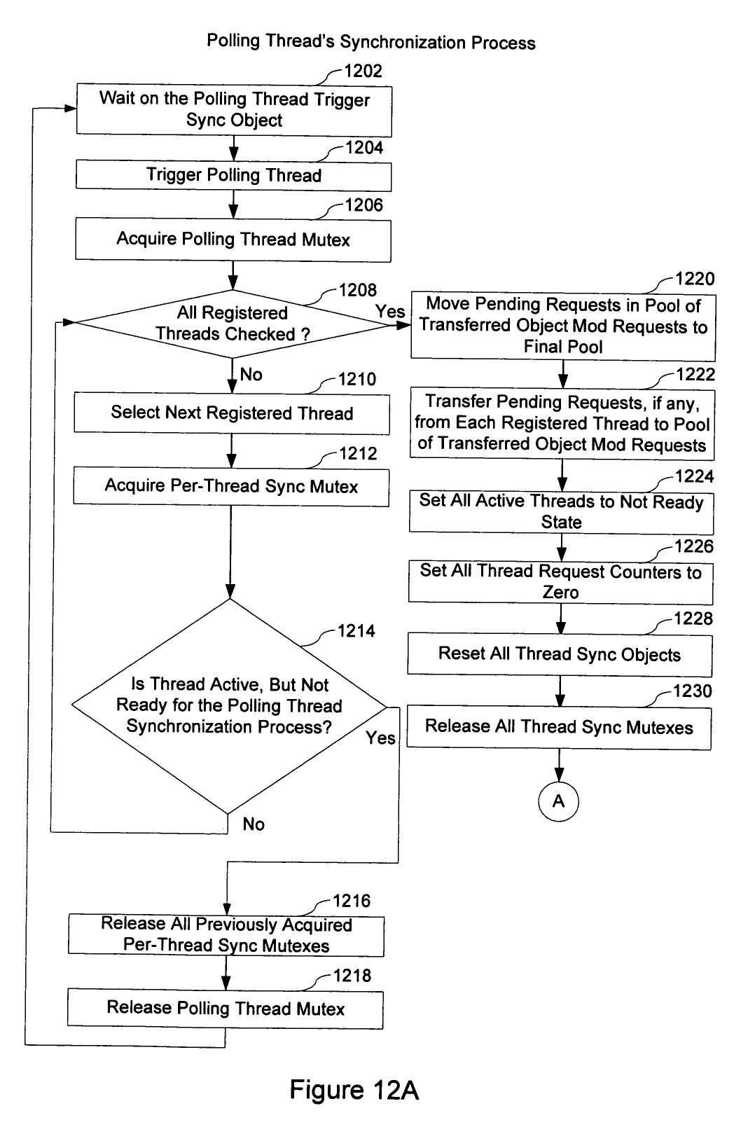

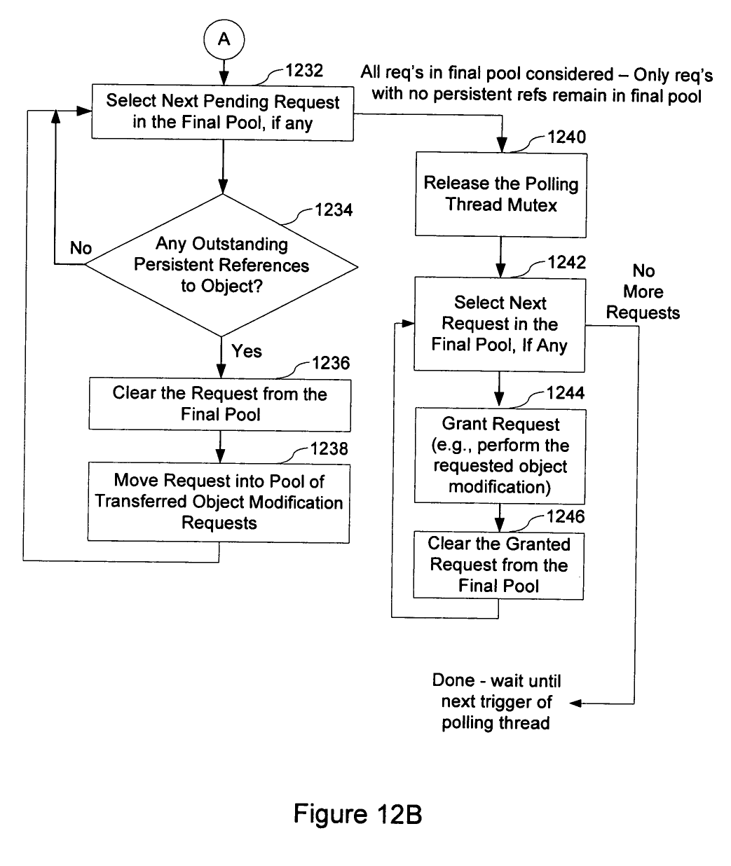

As described below, two different types of synchronization operations are used to maintain data coherency, namely individual application thread synchronization operations (examples of which are shown FIGS. 6-9) and polling thread synchronization operations (examples of which are shown in FIGS. 11-12).

After registering with polling thread 126, an application thread 124 can be in one of three different states:
(1) inactive—An “inactive” application thread 124 is synchronized with shared memory 128 prior to entering the inactive state, and cannot hold any non-persistent object references or acquire any new object references, either persistent or non-persistent. Thus, an inactive thread is always ready for polling thread synchronization operations.
(2) active, but not ready for polling thread synchronization operations—An “active, but not ready” application thread 124 can acquire both persistent and non-persistent references, but is not ready for polling thread synchronization operations because the application thread may have acquired one or more object references since its last application thread synchronization operation.
(3) active and ready for polling thread synchronization operations—An “active and ready” application thread 124 can acquire both persistent and non-persistent references, and is also ready for polling thread synchronization operations because the thread has flushed all information about the persistent object references it holds (if any) to shared memory during a recent application thread synchronization operation.

FIG. 6A is a flowchart representing a method of registering an application thread 124 with polling thread 126 in accordance with one embodiment of the present invention. Application thread 124 registers (602) with polling thread 126, e.g., by adding its thread ID to a linked list of registered threads 306. In some embodiments, an application thread 124 registers (602) itself with polling thread 126 by acquiring polling mutex 302, adding its thread ID to a linked list of registered threads 306, and releasing polling mutex 302.

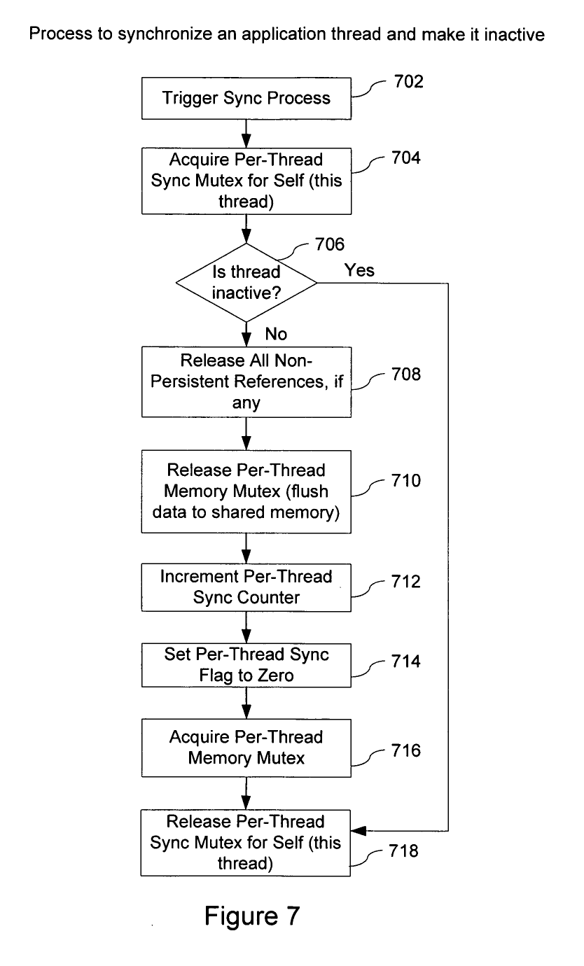

Conversely, to unregister from polling thread 126, in some embodiments, application thread 124: releases all previously acquired persistent and non-persistent references (e.g., FIGS. 4B and 5B); sets itself to an inactive state (e.g., FIG. 7); sets per-thread request synchronization object 224 or an analogous flag; waits for the per-thread request synchronization object 224 to be reset; acquires the polling thread mutex 302; acquires the per-thread sync mutex 202 for itself; transfers all the requests in its request queue 214 to the pool of transferred object modification requests 308; sets its per-thread object modification request counter 222 to zero; removes its thread ID from the polling processor's linked list of registered threads 306; releases the per-thread sync mutex 202 for itself; and releases polling thread mutex 302.

FIG. 6B is a flowchart representing a method of synchronizing an application thread 124 with shared memory 128 in accordance with one embodiment of the present invention.

Application thread 124 triggers (604) the application thread synchronization process (e.g., by signaling a condition variable). The triggering can occur either episodically or periodically. In some embodiments, the synchronization operations are performed in accordance with a prearranged schedule specified by the application thread.

Application thread 124 acquires (606) the per-thread sync mutex 202 for itself.

All non-persistent references, if any, in application thread 124 are released/deleted (608) prior to completing each iteration of the application thread synchronization operations. Consequently, during a polling thread synchronization process (examples of which are shown in FIGS. 11-12) the polling thread 126 does not need to evaluate or otherwise consider non-persistent references.

Application thread 124 executes (610) a memory barrier instruction to flush its data to shared memory 128; marks (612) itself as synchronized; and releases (614) the per-thread sync mutex 202 for itself.

FIG. 6C is a flowchart representing a method of executing a memory barrier instruction (610) and marking an application thread as synchronized (612) in more detail.

Application thread 124 releases (616) per-thread memory mutex 204 for itself to flush its data to shared memory 128; increments (618) per-thread sync counter 216 for itself to indicate that the application thread is ready for synchronization with the polling thread; and acquires (620) per-thread memory mutex 204 for itself to prepare for the next iteration of the application thread synchronization operation.

FIG. 7 is a flowchart representing a method of synchronizing an application thread 124 with shared memory 128 and making the application thread inactive in accordance with one embodiment of the present invention.

Application thread 124 triggers (702) the application thread synchronization process (e.g., by signaling a condition variable). The triggering can occur either episodically or periodically. In some embodiments, the synchronization operations are performed in accordance with a prearranged schedule specified by the application thread.

Application thread 124 acquires (704) the per-thread sync mutex 202 for itself.

Application thread 124 determines (706) whether it is already inactive. In some embodiments, this determination is made by checking the value of a flag, such as per-thread sync flag 220. In some embodiments, if the value of per-thread sync flag 220 is zero, the corresponding application thread 124 is inactive. Conversely, if the value of per-thread sync flag 220 is non-zero, the corresponding application thread 124 is active.

If application thread 124 is already inactive, then application thread 124 is already ready for polling synchronization operations, and application thread 124 releases (718) the per-thread sync mutex 202 for itself.

If application thread 124 is active, all non-persistent references, if any, in application thread 124 are released/deleted (708). Application thread 124 releases (710) per-thread memory mutex 204 for itself to flush its data to shared memory 128; increments (712) per-thread sync counter 216 for itself to indicate that the application thread is ready for synchronization with the polling thread; sets (714) per-thread sync flag 220 to zero to indicate that application thread 124 is inactive; acquires (716) per-thread memory mutex 204 for itself to prepare for the next iteration of the application thread synchronization operation; and releases (718) the per-thread sync mutex 202 for itself.

An application thread 124 that has synchronized itself with shared memory 128 and become inactive is always ready for the polling thread synchronization process.

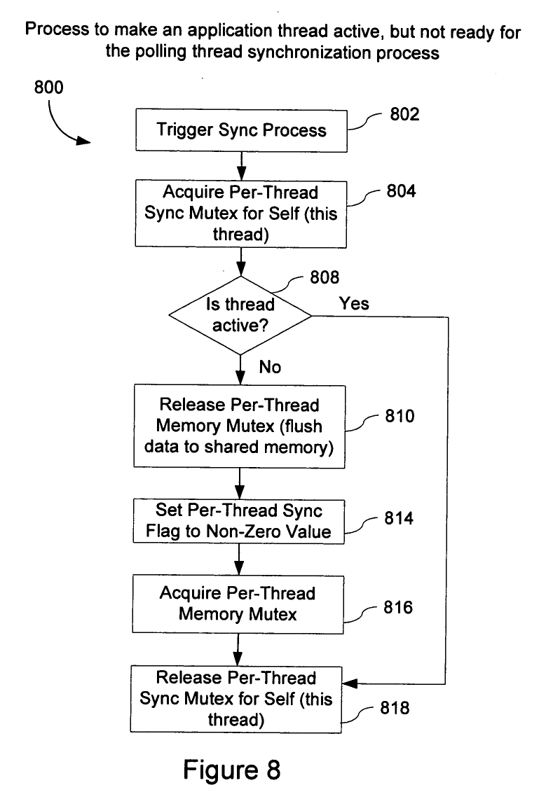

FIG. 8 is a flowchart representing a process 800 for making an application thread 124 active, but not ready for the polling thread synchronization process in accordance with one embodiment of the present invention.

Application thread 124 triggers (802) the application thread synchronization process (e.g., by signaling a condition variable). The triggering can occur either episodically or periodically. In some embodiments, the synchronization operations are performed in accordance with a prearranged schedule specified by the application thread.

Application thread 124 acquires (804) the per-thread sync mutex 202 for itself.

Application thread 124 determines (806) whether it is already active. In some embodiments, this determination is made by checking the value of a flag, such as per-thread sync flag 220. In some embodiments, if the value of per-thread sync flag 220 is non-zero, the corresponding application thread 124 is active. Conversely, if the value of per-thread sync flag 220 is zero, the corresponding application thread 124 is inactive.

If application thread 124 is already active, then application thread 124 releases (818) the per-thread sync mutex 202 for itself.

If application thread 124 is inactive, application thread 124 releases (810) per-thread memory mutex 204 for itself to flush its data to shared memory 128; sets (814) per-thread sync flag 220 to a non-zero value to indicate that application thread 124 is active; acquires (816) per-thread memory mutex 204 for itself to prepare for a next iteration of the application thread synchronization operation; and releases (818) the per-thread sync mutex 202 for itself.

In summary, the process 800 transitions an inactive application thread to an active thread that is not yet ready for synchronization with the polling thread.

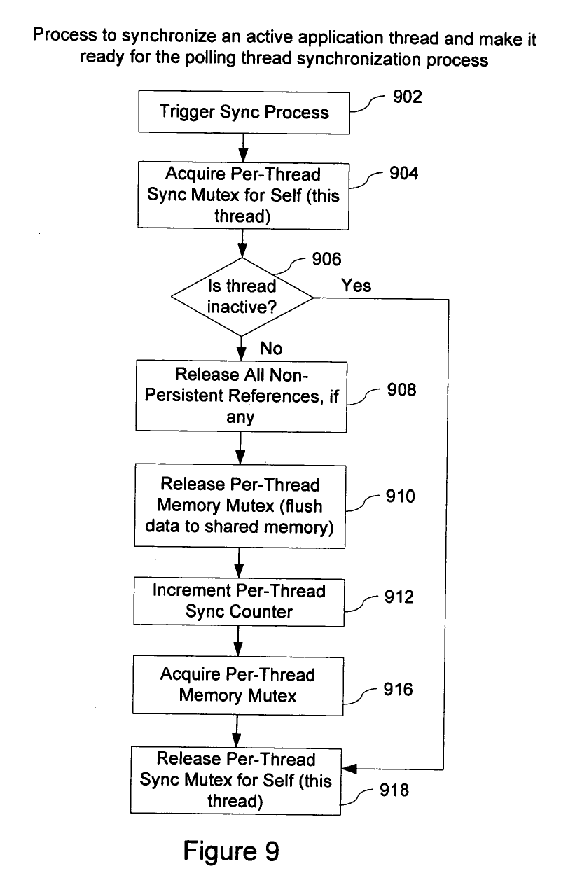

FIG. 9 is a flowchart representing a method of synchronizing an active application thread 124 with shared memory 128 and making the application thread ready for the polling thread synchronization process in accordance with one embodiment of the present invention.

Application thread 124 triggers (902) the application thread synchronization process (e.g., by signaling a condition variable). The triggering can occur either episodically or periodically. In some embodiments, the synchronization operations are performed in accordance with a prearranged schedule specified by the application thread.

Application thread 124 acquires (904) the per-thread sync mutex 202 for itself.

Application thread 124 determines (906) whether it is inactive. In some embodiments, this determination is made by checking the value of a flag, such as per-thread sync flag 220. In some embodiments, if the value of per-thread sync flag 220 is zero, the corresponding application thread 124 is inactive. Conversely, if the value of per-thread sync flag 220 is non-zero, the corresponding application thread 124 is active.

If application thread 124 is already inactive, then application thread 124 is already ready for polling synchronization operations, and application thread 124 releases (918) the per-thread sync mutex 202 for itself.

If application thread 124 is active, all non-persistent references, if any, in application thread 124 are released/deleted (908). Application thread 124 releases (910) per-thread memory mutex 204 for itself to flush its data to shared memory 128; increments (912) per-thread sync counter 216 for itself to indicate that the application thread is ready for synchronization with the polling thread; acquires (916) per-thread memory mutex 204 for itself to prepare for a next iteration of the application thread synchronization operation; and releases (918) the per-thread sync mutex 202 for itself. An active application thread 124 that has recently synchronized itself with shared memory 128 is ready for the polling thread synchronization process.

From another perspective, an active application thread 124 is said to have recently synchronized itself with shared memory 128 if it has performed the application thread synchronization process since the last time the polling thread completed an iteration of the polling thread synchronization process.

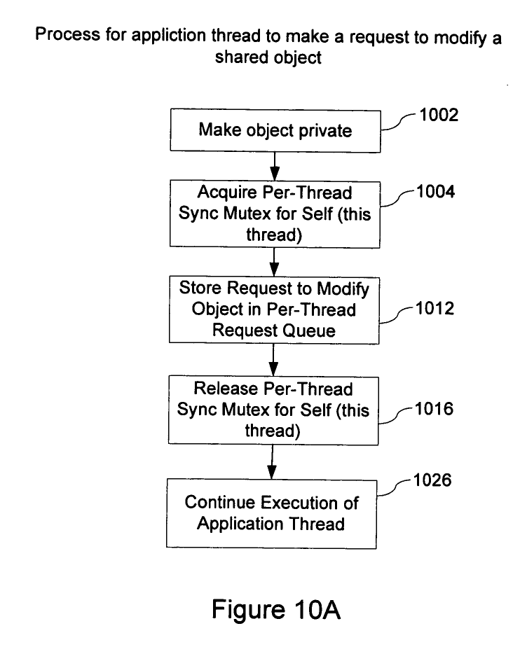

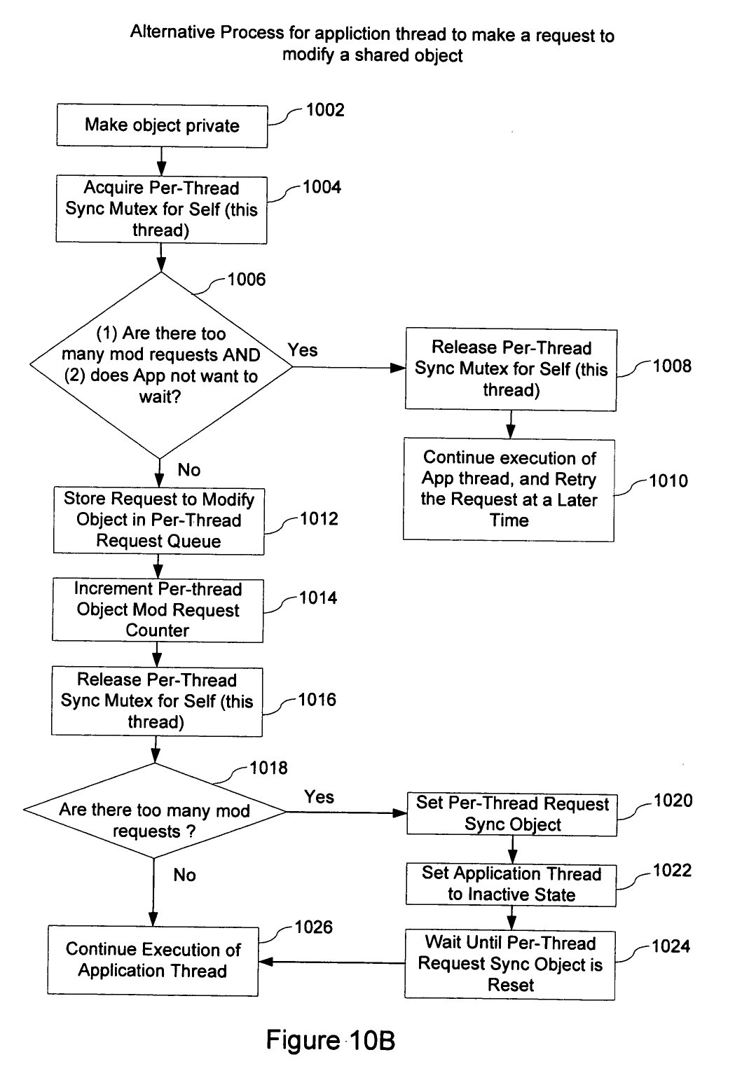

FIG. 10A is a flowchart representing a method for an application thread 124 to make a request to modify a shared object 130 in accordance with one embodiment of the present invention.

The shared object 130 is made private (1002) so that the object 130 cannot acquire new references. Previously acquired local pointers to the shared object 130 are permissible, but new global pointers to the shared object 130 are not. In some embodiments, the shared object 130 is made private by setting all global pointers to the object 130 to null. In some embodiments, the shared object 130 is made private by changing all global pointers to the object 130 to pointers to a privately owned object. In some embodiments, the per-thread memory mutex 204 is briefly unlocked and locked again before changing all global pointers to the object 130 into pointers to a privately owned object. In some embodiments, a StoreLoad or StoreStore style memory barrier instruction is executed before changing all global pointers to the object 130 into pointers to a privately owned object.

Application thread 124 acquires (1004) the per-thread sync mutex 202 for itself; stores (1012) the request to modify the object 130 in its per-thread request queue 214; releases (1016) the per-thread sync mutex 202 for itself; and continues execution (1026). Note that in this embodiment there is no limit on the number of modification requests in request queue 214 and application thread 124 can continue execution (1026) without waiting for the requests to be granted.

FIG. 10B is a flowchart representing another method for an application thread 124 to make a request to modify a shared object 130 in accordance with one embodiment of the present invention. This method is essentially the same as that shown in FIG. 10A, except that a limit is put on the number of pending modification requests and the application thread 124 can wait if there are too many modification requests pending. Putting a limit on the number of pending modification requests ensures that application thread 124 will not exhaust all of the system memory by making too many object modification requests.

Application thread 124 determines (1006) whether there are too many modification requests (e.g., by determining whether per-thread object modification request counter 222 violates a limit) and whether the application does not want to wait if there are too many requests. If there are too many modification requests and the application does not want to wait, application thread 124 releases (1008) the per-thread sync mutex 202 for itself, continues execution (1010) and retries the request at a later time.

If there are not too many modification requests, application thread 124 stores (1012) the request to modify the object 130 in its per-thread request queue 214; increments (1014) its per-thread object modification request counter 222; and releases (1016) the per-thread sync mutex 202 for itself.

Application thread 124 determines (1018) whether there are too many modification requests (e.g., by determining whether per-thread object modification request counter 222 violates a limit). If there are too many modification requests, application thread 124 sets (1020) per-thread request synchronization object 224 or an analogous flag; sets (1022) application thread 124 to the inactive state; and waits (1024) until the per-thread request synchronization object 224 is reset before it continues execution (1026). If there are not too many modification requests, application thread 124 continues execution (1026) without waiting for the requests to be granted.

FIG. 11A is a flowchart representing a process for polling thread synchronization in accordance with one embodiment of the present invention.

Polling thread 126 is triggered (1102), e.g., using polling trigger synchronization object 304. In some embodiments, polling thread 126 is triggered after a predetermined event or a predetermined amount of time.

Polling thread 126 checks (1104) all of the registered application threads 124 (e.g., the application threads 124 in the linked list of registered threads 306) to determine if all of these threads 124 are ready for the polling thread synchronization process. (As described below, FIG. 11C illustrates an exemplary process for performing this check.) If all of the registered threads 124 are ready for the polling thread synchronization process, the process continues. If not, the polling thread synchronization process releases all previously acquired registered threads synchronization mutexs 202, then stops and restarts at the next trigger (1102) of the polling thread.

If all of the registered threads 124 are ready for the polling thread synchronization process, the polling thread 126 moves (1106) the pending requests in the pool of transferred object modification requests 308 to the final pool of object modification requests 314. Any pending requests (e.g., requests in the request queues 214 of each application thread 124) are transferred (1108) from each registered application thread 124 to the pool of transferred object modification requests 308 in polling thread 126.

The polling thread 126 evaluates whether each pending object modification request in the final pool 314 can be granted by selecting (1110) the next pending object modification request in the final pool 314, if any, and determining (1112) if there are any outstanding persistent references to the corresponding object 130. In some embodiments, determining if there are any persistent references to the data object includes checking the per thread array of counters 208 in each registered application thread 124 to determine whether any application thread 124 has a non-zero reference count 212 for an object ID 210 that corresponds to the data object in question.

If there are outstanding persistent references to the corresponding object 130, the object modification request is not granted and the polling thread moves on to evaluate the next pending request. If there are no outstanding persistent references to the corresponding object 130, the polling thread 126 grants (1114) the object modification request, clears (1116) the granted request from the final pool 314, and selects (1110) the next pending request in the final pool 314.

Once all of the pending requests in the final pool have been evaluated, the active application threads 124 are marked (1118) as un-synchronized, e.g., (1) by setting the value of its per-thread synchronization counter 216 equal to the value of its old per-thread synchronization counter 218 or (2) by setting a flag (not shown in FIG. 2). The polling thread 126 releases (1120) the per-thread sync mutex 202 of each registered application thread 124. (As described below with respect to FIG. 11C, the per-thread sync mutexes 202 were acquired when the application threads 124 were checked to determine if they were all ready for the polling thread synchronization process.) One iteration of the polling thread synchronization process is complete and the polling thread 126 waits until the next trigger (1102) to repeat the process.

FIG. 11B is a flowchart representing another process for polling thread synchronization in accordance with one embodiment of the present invention. This process is essentially the same as that shown in FIG. 11A, except in this embodiment additional operations are used to impose a limit on the number of pending modification requests in each application thread 124. After a pending request is granted (1114), the per-thread object modification request counter 222 in the application thread 124 associated with the granted request is decremented (1122) and the per-thread request synchronization object 224 in the application thread 124 associated with the granted request is reset (1124).

FIG. 11C is a flowchart representing a method for checking registered threads 124 to determine if all such threads are ready for the polling thread synchronization process in accordance with one embodiment of the present invention.

Polling thread 126 determines (1150) if all of the registered application threads 124 (e.g., the application threads 124 in the linked list of registered threads 306) have been checked. If threads 124 remain to be checked, polling thread 126 selects (1152) the next registered thread 124 that needs to be checked and acquires (1154) the per-thread synchronization mutex 202 for that thread 124.

The polling thread determines (1156) if that thread 124 is in an active state, but not ready for the polling thread synchronization process. In some embodiments, this determination is made by evaluating: (1) if the value for the per-thread sync counter 216 for that thread 124 is equal to the value for the old per-thread sync counter 218 for that thread 124 and (2) if the per-thread sync flag 220 for that thread 124 is set to a non-zero value. If the value for the per-thread sync counter 216 is equal to the value for the old per-thread sync counter 218, then that thread 124 has not recently synchronized with shared memory 128. If the per-thread sync flag 220 is set to a non-zero value, then that thread 124 is active. If both (1) and (2) are true, then that thread 124 is in an active state, but not ready for the polling thread synchronization process. Thus, the polling thread synchronization process releases all previously acquired registered threads synchronization mutexs 202, then stops and waits for the next trigger (1102).

If either (1) or (2) are not true, then that thread 124 is ready for the polling thread synchronization process, i.e., that thread 124 is either “inactive” (per-thread sync flag 220 is set to zero) or “active and ready for synchronization operations” (per-thread sync counter 216 not equal to the old per-thread sync counter 218 and per-thread sync flag 220 set to a non-zero value). If that thread 124 is either “inactive” or “active and ready for synchronization operations,” the polling thread 126 moves on to determine (1150) if all of the registered threads 124 have been checked. If all of the registered application threads 124 have been checked and all of the threads 124 are ready for the polling thread synchronization process (i.e., there are no threads 124 that are “active, but not ready for polling thread synchronization operations”), then the polling thread 126 continues with the polling thread synchronization process.

FIGS. 12A and 12B are a flowchart representing another process for polling thread synchronization in accordance with one embodiment of the present invention.

Polling thread 126 waits (1202) on polling trigger synchronization object 304 until polling trigger synchronization object 304 is triggered (1204). In some embodiments, polling thread 126 is triggered after a predetermined event or a predetermined amount of time. Polling thread 126 acquires (1206) polling thread mutex 302 to protect polling thread 126's variables during the polling thread synchronization process.

Polling thread 126 checks (1208) all of the registered application threads 124 (e.g., the application threads 124 in the linked list of registered threads 306) to determine if all of these threads 124 are ready for the polling thread synchronization process. If threads 124 remain to be checked, polling thread 126 selects (1210) the next registered thread 124 that needs to be checked and acquires (1212) the per-thread synchronization mutex 202 for that thread 124.

The polling thread determines (1214) if that thread 124 is in an active state, but not ready for the polling thread synchronization process. In some embodiments, this determination is made by evaluating: (1) if the value for the per-thread sync counter 216 for that thread 124 is equal to the value for the old per-thread sync counter 218 for that thread 124 and (2) if the per-thread sync flag 220 for that thread 124 is set to a non-zero value. If the value for the per-thread sync counter 216 is equal to the value for the old per-thread sync counter 218, then that thread 124 has not recently synchronized with shared memory 128. If the per-thread sync flag 220 is set to a non-zero value, then that thread 124 is active. If both (1) and (2) are true, then that thread 124 is in an active state, but not ready for the polling thread synchronization process. Thus, the polling thread releases (1216) all previously acquired per-thread synchronization mutexes 202, releases (1218) the polling thread mutex 302, and waits for the next trigger (1202).

If either (1) or (2) are not true, then that thread 124 is ready for the polling thread synchronization process, i.e., that thread 124 is either “inactive” (per-thread sync flag 220 is set to zero) or “active and ready for synchronization operations” (per-thread sync counter 216 not equal to the old per-thread sync counter 218 and per-thread sync flag 220 set to a non-zero value). If that thread 124 is either “inactive” or “active and ready for synchronization operations,” the polling thread 126 moves on to determine (1208) if all of the registered threads 124 have been checked. If all of the registered application threads 124 have been checked and all of the threads 124 are ready for the polling thread synchronization process (i.e., there are no threads 124 that are “active, but not ready for polling thread synchronization operations”), then the polling thread 126 continues with the polling thread synchronization process.

If all of the registered threads 124 are ready for the polling thread synchronization process, the polling thread 126 moves (1220) the pending requests in the pool of transferred object modification requests 308 to the final pool of object modification requests 314. Any pending requests (e.g., requests in the request queues 214 of each application thread 124) are transferred (1222) from each registered application thread 124 to the pool of transferred object modification requests 308 in polling thread 126.

All active threads 124 are set (1224) to the “active, but not ready state.” For example, this is accomplished for each active thread 124, (1) by setting the value of its per-thread synchronization counter 216 equal to the value of its old per-thread synchronization counter 218 or (2) by setting a flag (not shown in FIG. 2).

Per-thread object modification request counters 222 in all registered threads 124 are set (1226) to zero. Per-thread request synchronization objects 224 in all registered threads 124 are reset (1228). In embodiments where there is a user-defined limit on the number of requests in the pool of transferred object requests 308 or in the final pool 314, the per-thread request synchronization objects 224 in all registered threads 124 are only reset (1228) if the user-defined limit is not violated. In such embodiments, the polling thread includes a register or counter (not shown in FIG. 3) in which the polling thread maintains a count of the object requests in the pool of transferred object requests 308 or in the final pool 314. All per-thread synchronization mutexes 202 acquired by the polling thread 126 are released (1230).

The polling thread 126 evaluates whether each pending object modification request in the final pool 314 can be granted by selecting (1232) the next pending object modification request in the final pool 314, if any, and determining (1234) if there are any outstanding persistent references to the corresponding object 130. As noted above, in some embodiments, determining if there are any persistent references to the data object includes checking the per thread array of counters 208 in each registered application thread 124 to determine whether any application thread 124 has a non-zero reference count 212 for an object ID 210 that corresponds to the data object in question.

If there are outstanding persistent references to the corresponding object 130, the object modification request is cleared (1236) from the final pool 314; the object modification request is moved back into the pool of transferred object modification requests 308; and the polling thread 126 selects (1232) the next pending request, if any, in the final pool 314.

If there are no outstanding persistent references to the corresponding object 130, the polling thread 126 moves on and selects (1232) the next pending request, if any, in the final pool 314. After all pending requests in final pool have been evaluated (1234) (for outstanding persistent references to the corresponding objects 130), only pending requests with no persistent references to the corresponding objects will remain in the final pool 314.

The polling thread releases the polling thread mutex (1240).

The polling thread 126 selects (1242) the next pending object modification request in the final pool 314; grants (1244) the request (e.g., by performing the requested object modification, calling a pointer to a function, or by sending the request to another thread, where the modification is performed); clears (1246) the granted request from the final pool 314; and selects (1242) the next pending object modification request in the final pool 314. When there are no more pending requests in the final pool 314, one iteration of the polling thread synchronization process is complete and the polling thread 126 waits (1202) until the next trigger to repeat the process.

As part of the polling thread synchronization processes described above, a polling thread 126 receives, e.g., via (1108) or (1222), a request from one application thread 124 in a plurality of application threads to modify a data object 130 shared by the plurality of application threads; determines, e.g., via (1112) or (1234), if there are any persistent references to the data object 130 by application threads in the plurality of application threads; and grants, e.g., via (1114) or (1244), the request if there are no persistent references to the data object 130 by application threads in the plurality of application threads. In some embodiments, the request to modify the data object 130 is a request to delete the data object 130 or a request to write to the data object 130. In some embodiments, granting the request includes the polling thread 126 transferring the request to the data object 130. In some embodiments, the one application thread in the plurality of application threads submits the request to modify the data object 130 asynchronously with respect to the synchronization operations of the one application thread.

Each application thread 124 in the plurality of application threads performs (e.g., see FIGS. 6B, 6C, 7, 8, and 9) synchronization operations episodically or periodically, with each performance of the synchronization operations comprising an iteration of the synchronization operations. In some embodiments, each application thread 124 in the plurality of application threads performs synchronization operations using a mutex specific to the application thread. In some embodiments, each application thread 124 uses operating system specific information to determine if the application thread has recently executed an operation that acts like a memory barrier (e.g., syscalls or context switches). In some embodiments, each application thread in the plurality of application threads performs a memory barrier instruction in conjunction with performing each of the application thread's synchronization operations. In some embodiments, the polling thread 126 episodically or periodically uses operating system specific information to determine if an application thread 124 has recently executed an operation that acts like a memory barrier; however, non-persistent references are not used in such embodiments.

In some embodiments, application threads 124 in the plurality of application threads are capable of maintaining a persistent reference over a plurality of successive iterations of the application thread synchronization operations. In some embodiments, at least one application thread 124 in the plurality of application threads maintains a persistent reference over a plurality of successive iterations of the application thread's synchronization operations. In some embodiments, at least one application thread 124 in the plurality of application threads acquires a plurality of persistent references between successive iterations of the application thread's synchronization operations. In some embodiments, a persistent reference exists in a respective application thread both before and after a respective synchronization operation of the application thread. In some embodiments, a persistent object reference exists in two successive epochs of an application thread 124.

Each application thread 124 in the plurality of application threads deletes, e.g. via (506), all of the application thread's non-persistent references, if any, prior to completing each iteration of the application thread's synchronization operations.

In some embodiments, each application thread 124 in the plurality of application threads registers with the polling thread 126.

Each application thread 124 in the plurality of application threads continues execution [e.g., (1026) after making requests to modify data objects shared by the plurality of application threads (i.e., without waiting for the requests to be granted or executed).

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method, comprising:
receiving a request at a polling thread from one application thread in a plurality of application threads to modify a data object shared by the plurality of application threads, wherein each application thread in the plurality of application threads
registers with the polling thread,
performs synchronization operations episodically or periodically, each performance of the synchronization operations comprising an iteration of the synchronization operations,
deletes all of the application thread's non-persistent references, if any, prior to completing each iteration of the synchronization operations,
is capable of maintaining a persistent reference over a plurality of successive iterations of the synchronization operations, and
continues execution after making requests to modify data objects shared by the plurality of application threads, without waiting for the requests to be granted;
determining if there are any persistent references to the data object by application threads in the plurality of application threads; and
granting the request if there are no persistent references to the data object by application threads in the plurality of application threads.

2. A computer-implemented method, comprising:
receiving a request at a polling thread from one application thread in a plurality of application threads to modify a data object shared by the plurality of application threads, wherein each application thread in the plurality of application threads
performs synchronization operations episodically or periodically, each performance of the synchronization operations comprising an iteration of the synchronization operations,
deletes all of the application thread's non-persistent references, if any, prior to completing each iteration of the synchronization operations, and
continues execution after making requests to modify data objects shared by the plurality of application threads;
determining if there are any persistent references to the data object by application threads in the plurality of application threads; and
granting the request if there are no persistent references to the data object by application threads in the plurality of application threads.

3. The method of claim 2, wherein at least one application thread in the plurality of application threads acquires a plurality of persistent references between successive iterations of the synchronization operations.

4. The method of claim 3, wherein a persistent reference exists in a respective application thread both before and after a respective synchronization operation of the application thread.

5. The method of claim 3, wherein a persistent reference exists in two successive epochs of an application thread.

6. The method of claim 2, wherein application threads in the plurality of application threads are capable of maintaining a persistent reference over a plurality of successive iterations of the synchronization operations.

7. The method of claim 2, wherein at least one application thread in the plurality of application threads maintains a persistent reference over a plurality of successive iterations of the synchronization operations.

8. The method of claim 2, wherein each application thread in the plurality of application threads registers with the polling thread.

9. The method of claim 2, wherein the one application thread in the plurality of application threads submits the request to modify the data object asynchronously with respect to the synchronization operations of the one application thread.

10. The method of claim 2, wherein each application thread in the plurality of application threads performs a memory barrier instruction in conjunction with performing each of the application thread's synchronization operations.

11. The method of claim 2, wherein an application thread in the plurality of application threads acquires a persistent reference to an object without using any synchronization operations and without using any memory barrier operations.

12. The method of claim 2, wherein the request to modify the data object is a request to delete the data object or a request to write to the data object.

13. The method of claim 2, including maintaining at the polling thread a list of the application threads that have registered with the polling thread.

14. The method of claim 2, wherein each application thread in the plurality of application threads performs synchronization operations using a mutex specific to the application thread.

15. The method of claim 2, wherein performing the synchronization operations periodically or episodically comprises performing the synchronization operations in accordance with a prearranged schedule specified by the application thread.

16. The method of claim 2, wherein determining if there are any persistent references to the data object includes checking a per thread array of counters.

17. The method of claim 2, wherein granting the request includes the polling thread transferring the request to the data object.

18. A multiprocessor computer system, comprising:
a main memory;
a plurality of processors; and
a program, stored in the main memory and executed by the plurality of processors, the program including:
instructions for receiving a request at a polling thread from one application thread in a plurality of application threads to modify a data object shared by the plurality of application threads, wherein each application thread in the plurality of application threads
performs synchronization operations episodically or periodically, each performance of the synchronization operations comprising an iteration of the synchronization operations,
deletes all of the application thread's non-persistent references, if any, prior to completing each iteration of the synchronization operations, and
continues execution after making requests to modify data objects shared by the plurality of application threads;
instructions for determining if there are any persistent references to the data object by application threads in the plurality of application threads; and
instructions for granting the request if there are no persistent references to the data object by application threads in the plurality of application threads.

19. A computer-program product, comprising:
a computer readable storage medium and a computer program mechanism embedded therein, the computer program mechanism comprising instructions, which when executed by a multiprocessor computer system, cause the multiprocessor computer system to:
receive a request at a polling thread from one application thread in a plurality of application threads to modify a data object shared by the plurality of application threads, wherein each application thread in the plurality of application threads
performs synchronization operations episodically or periodically, each performance of the synchronization operations comprising an iteration of the synchronization operations,
deletes all of the application thread's non-persistent references, if any, prior to completing each iteration of the synchronization operations, and
continues execution after making requests to modify data objects shared by the plurality of application threads;
determine if there are any persistent references to the data object by application threads in the plurality of application threads; and
grant the request if there are no persistent references to the data object by application threads in the plurality of application threads.

20. A multiprocessor computer system, comprising:
means for receiving a request at a polling thread from one application thread in a plurality of application threads to modify a data object shared by the plurality of application threads, wherein each application thread in the plurality of application threads
performs synchronization operations episodically or periodically, each performance of the synchronization operations comprising an iteration of the synchronization operations,
deletes all of the application thread's non-persistent references, if any, prior to completing each iteration of the synchronization operations, and
continues execution after making requests to modify data objects shared by the plurality of application threads;
means for determining if there are any persistent references to the data object by application threads in the plurality of application threads; and
means for granting the request if there are no persistent references to the data object by application threads in the plurality of application threads.
